(19) United States
(12) Patent Application Publication
(10) Pub. No.: US 2005/0149393 A1
(43) Pub. Date: Jul. 7, 2005

(54) Lottery credit card rewards system

(76) Inventor: Eugene Leof, Abington, PA (US)

Correspondence Address: National IP Rights Center, LLC, Suite 400, 550 Township Line Road, Blue Bell, PA, 19422, US

(21) Appl. No.: 10/753,234

(22) Filed: Jan. 6, 2004

(51) Int. Cl. G06F 17/60

(52) U.S. Cl. 705/14

(57) ABSTRACT

A credit card loyalty program, based upon a state lottery. The end user receives a credit card with a lottery reward feature. As purchases are made, the customer accumulates credits which can be used to purchase lottery tickets via toll free number, mail or online website.

### FIELD OF THE INVENTION

The present invention is directed to a rewards program for credit card holders and debit cardholders that is tied to state or governmental lotteries. In particular, the present invention is directed to a system in which the reward of state or governmental lottery tickets is tied to a credit card and/or debit card awards or rewards program to reward Lottery cardholders based on their individual purchasing power at over 28 million merchants globally with earned (free) lottery ticket awards. Awarded lottery tickets are accessible to Lottery Cardholders through multiple channels.

### BACKGROUND OF THE INVENTION

The present invention is directed to a system and method for applying lottery prizes to a credit card and debit card rewards system. Credit cards and/or debit cards typically comprise a plastic payment system, with which an authorized user purchases services and/or merchandise and the like. Credit cards and/or debit cards are generally issued by a state or federally chartered bank or financial institution and provide a mechanism by which a user purchases goods without an immediate, direct exchange of cash with the exception of debit cards which create a real time withdrawal from the cardholder's bank account. During a given payment period, the user may either pay the outstanding balance or, as a matter of choice, revolve the balance for later payment with accompanying interest or finance charges for the period during which repayment of the debt is deferred.

Increasingly, credit cards and/or debit cards are being issued by banks, financial institutions and the like in association with other organizations, for example, such as commercial enterprises which themselves offer or sell goods and/or services. This phenomenon, known as co-branding, of which there are greater than 6,000 relationships with colleges and universities, non-profit organizations, charities and consumer businesses in the U.S. alone, provides a credit card that typically carries the name of a commercial company, (e.g. American Airlines, United Airlines, Hilton Hotels, BP Amoco, Dell Computer, Office Depot) and in which the commercial company or co-branding “partner” brings to the card holder or user added benefits which will generally assist the partner in the sale of its goods or services to the card user. Well known and successful examples of such co-branded cards include the General Motors MasterCard credit card—offering users up to a five-percent rebate on user-purchased General Motors automobiles and airline-partnered credit cards and/or debit cards which award the card user frequent flyer mileage on the basis of user-accrued card charges. Also well known are the American Airlines AAdvantage Card, the Marriott Rewards Card, and others.

Lotteries are a $42.9 billion dollar industry in North America. In the United States, over 38 states have or participate in lottery-type games. Two additional states have approved lotteries to commence in 2004. The average annual purchases of lottery tickets nationwide is $169 per capita. Lotteries award over fifty million dollars ($50,000,000) in daily cash awards in North America alone. Lotteries are also played in over seventy countries.

In the United States, state operated lotteries help fund a number of important public and societal functions including education, health care, the building of sports facilities and senior citizen care. However, with the growth and proliferation of other forms of legalized gambling such as Casino gambling, state lotteries have had to market much harder for the public's gambling dollar. Accordingly, lotteries have had to utilize more aggressive marketing and sales techniques including high cost advertising, high visibility, high cost marketing packages and other techniques.

Until this time and during a period of credit card industry rewards program growth, no one entity or individual has developed a consumer-friendly, multiple access system for linking lottery ticket awards to everyday credit and debit card purchases such as is delineated herein, including imbedded transactional security and privacy. There has not been an effective system for incorporating a lottery with a credit card rewards program.

There have been several patents directed to the use of lotteries in the context of premiums and awards. U.S. Patent Publication No. 2001/0039511 is directed to an electronic point of sale and Internet promotional method and system that promotes customer purchases and loyalty at member merchants. The system records customer sales data and, under the control of one or more merchants and a sales promotion computer system, involves generating and storing random numbers at the sales promotion computer system, loading awards records on the promotion system consisting of sales criteria which define customer award entitlements, and comparing customer transaction data received from a sales system with the award records at the promotion computer system to determine if the customer is entitled to an award. If so, one or more of the numbers are printed on a document associated with each transaction. The printed numbers constitute a lottery ticket in a lottery to be drawn on a periodic basis with prizes awarded to ticket holders having a number or numbers which are the same as or are a defined sub-set of the numbers drawn.

U.S. Pat. No. 5,513,102 to Auriemma discloses data processing methods for enhancing the value of a substantially conventional credit card so as to enhance a user's perception of the desirability of holding and using the card and encourage increased use of the card for its normal utility as a payment device. The user earns, for each transaction amount or payment amount of at least a predetermined size, a coupon redeemable by the user for a lottery ticket by which the user has an opportunity to recover at least a portion and potentially in excess of the user's transaction-based expenditures or payments. Transaction amounts or payment amounts in excess of the predetermined size but insufficient to earn an additional coupon are stored and then applied to user transaction or payment amounts during the next-subsequent billing period.

The problem with the prior art systems such as disclosed by Auriemma is that they do not provide either convenience or rapid access of number to the user. The Auriemma system is based upon a system of issued coupons which have to be redeemed for actual tickets. In such systems, there is typically a long period between the time when the purchase is made and the credit is issued. Such a system does not address or utilize the types of high speed or instant access that is provided by an Internet site, toll free telephony and card statement messaging. Such a system also does not address transactional security and potential identity theft and privacy, mandatory requirements in the present environment for the protection of consumers envisioned as carrying the Lottery Card.

Many lottery players only play periodically, often when a major jackpot is high. Several recent “Powerball” and “Mega Millions” drawings exceed 300 million dollars ($300,000,000) Players thus need to quickly access or obtain their numbers. A further drawback is that the redemption process can be time consuming. In addition to having to verify the coupons, large lottery drawings typically create long lines at retailers. In a major jackpot drawing, people have been known to wait for two hours or more to purchase tickets. These lines actually dissuade people from playing.

Accordingly it is a principal object of the Lottery Card invention to provide methodology for enhancing the value of a conventional credit card or debit card through product differentiation by—(1) greatly increasing the size and selection of Lottery ticket awards linked to card purchasing, (2) providing method of delivering the awards through multiple channel (Internet-toll free telephone-card statement messaging) access to the Lottery Cardholder, and (3) by delivering state-of-art transactional security and transactional privacy. Not only will the Lottery Cardholder (potential user) realize tangible benefits, state lotteries will benefit with increased ticket sales from card issuers as card issuers fulfill their fiduciary responsibility based on individual Lottery Cardholder purchasing. This will drive new revenues to the state, supplementing as examples, educational, senior citizen and healthcare funding, increasing thirty-eight state's revenue streams.

It is a further object that when a cardholder member makes purchases, the cardholders can earn credits toward lottery tickets from the state lottery games of their choice. The option is designed to facilitate a turnkey solution between the card issuer and the state lottery and the third party management processor. State lotteries thereby gain a new income stream in a time of budgetary constraints.

The invention's system includes two interactive databases managed by members of a strategic alliance between multiple credit card issuers and one or more lottery database contractors. One database resides at the card issuer for the purpose of tracking card transactions, payments, revolving account balances and statement generation; and one at the lottery processor for accrual of earned credits derived from Lottery Card purchases by type of Lottery game to be played, by pot dollar amount, by pooling with like brand Lottery Cardholders, by pre-selected timing including generation of ticket purchases (in accordance with Lottery Cardholder's written, submitted direction) for remittance to the card issuer; and maintenance and periodic audit of the cardholder's earned lottery ticket account on an ongoing basis.

It is an object of the present invention to provide a credit card and debit card awards program in which a customer can accumulate dollar credits cash rewards to be applied to the purchase of lottery tickets is a timely, customer-friendly basis without unreasonable lead times as a result of open architecture which permits the lottery cardholder to utilize the multiple channel access available only to lottery cardholders, e.g. Internet, dedicated toll free numbers and statement messaging.

It is a further object of the present invention to provide a credit cards and/or debit cards award program and system whereby customers can designate the types of lottery games they wish to play, according to state and configuration.

It is yet a further object of the present invention to provide a system whereby lottery players can pool their purchases with other players and can use a variety of number generation systems.

It is still a further object of the present invention to provide a system whereby lottery players can purchase tickets at a time when the lottery reaches a certain high level.

### SUMMARY OF THE INVENTION

A method of issuing lottery tickets to an authorized user of a credit card or debit card who purchases makes everyday purchases of every type of commodity from over 28 million merchants globally on the card comprising the following steps: storing in a database an amount of each of one or more purchases on the credit card by an authorized lottery cardholder of the card; defining and storing in the data processing device a number representing a monetary amount for which the lottery cardholder can receive a lottery ticket; numbers can be printed online; calculating in the data processing device a quantity of the lottery tickets earned by the lottery cardholder based on the quantity of purchases by the lottery cardholder; and crediting the lottery cardholder with the lottery tickets.

In a further novel customer loyalty game is played according to the following steps: registering a customer for a lottery loyalty promotion associated with a credit card; and providing at least one lottery ticket to the customer, based upon the monetary amount a customer purchases;

A system for operating a customer loyalty game played according to the following steps: input means for inputting customer information and registering the customer to participate in the lottery credit card based customer loyalty game; means under the control of a program for determining the award of lottery tickets based upon pre-selected purchasing parameters; means for assigning the lottery tickets and distributing them to a Lottery Cardholder based upon the spending level of the customer with respect to the purchasing parameters; and means for providing the end user with the ability to access the numbers.

### BRIEF DESCRIPTION OF THE FIGURES

FIG. 1 is block diagram of the major operational features of the present invention.

FIG. 1a illustrates the relationship between the card issuer and the Lottery Cardholder.

FIG. 2 is a block diagram of the operation of the present invention.

FIG. 3 illustrates a customer intake form in accordance with the invention.

FIGS. 4a -4b illustrate online user screens in accordance with the present invention.

### DETAILED DESCRIPTION OF THE PREFERRED EMBODIMENT

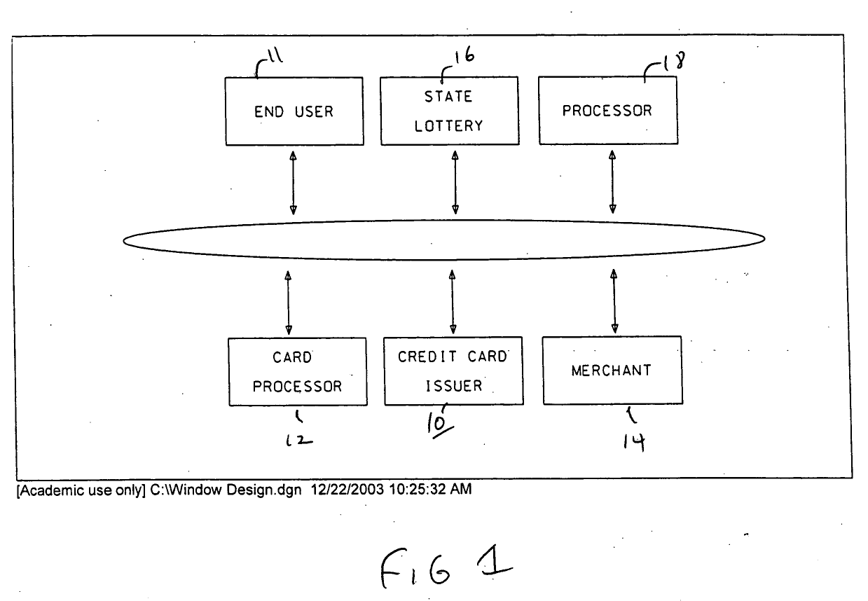

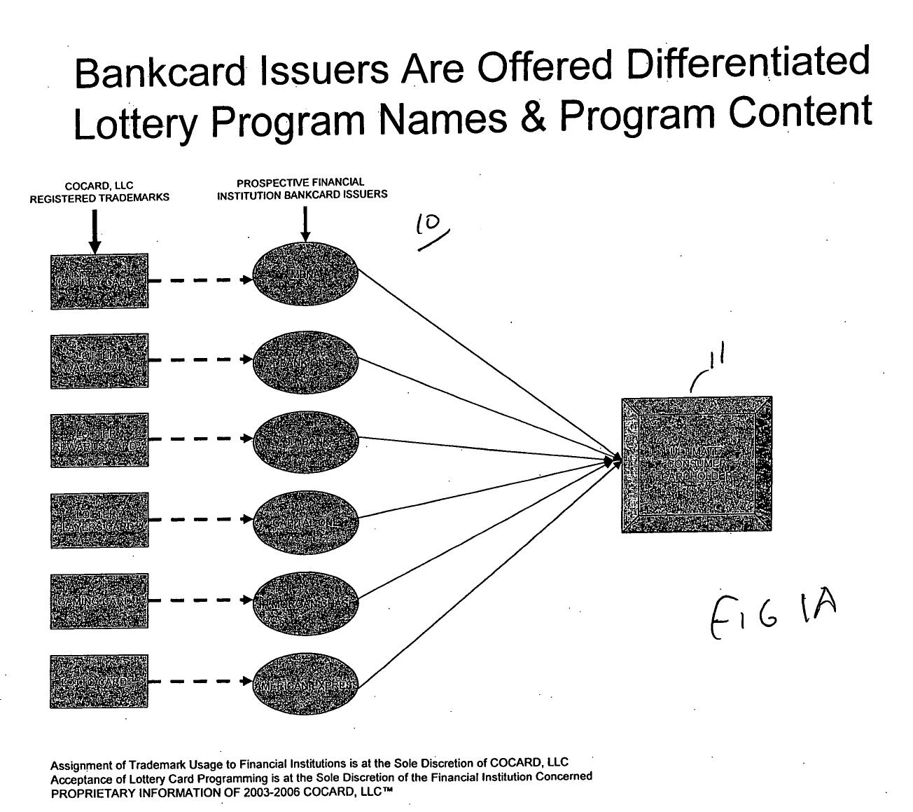

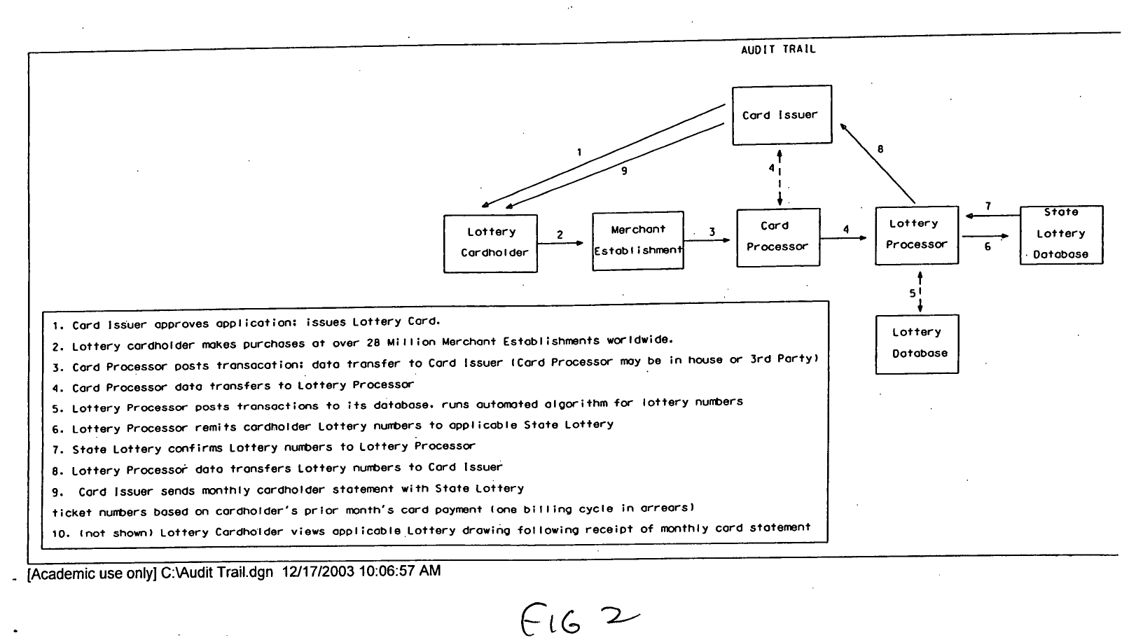

The present invention is described with reference to the enclosed Figures where the same numbers are utilized where applicable. Referring to FIG. 1, an over all description of the major components of the present invention is shown. The invention comprises a number of basic components which comprise the key elements of the system.

As shown in FIGS. 1 and 1a, the basic elements initially comprise a card issuer 10. Until this time and during a period of credit card industry rewards program growth, no one entity or individual has developed a consumer-friendly, multiple access system for linking lottery ticket awards to everyday credit and debit card purchases such as is delineated herein, including imbedded transactional security and privacy. In a preferred embodiment, the card issuer 10 is typically a bank or financial (e.g. MBNA, BANK ONE, Citibank, etc.) working within an organization such as Discover and/or American Express which processes and approves the application and then issues the credit card with a state lottery component. The term credit and/or debit card are used interchangeably herein for the purposes of the invention. Visa/Mastercard also provides marketing support. The second element, a credit card processor 12 is a third party clearing house entity which manages and authorizes credit card transactions and which handles the clearance and payment of approved transactions to a merchant 14 who processes credit card purchases made by the end user consumer 11. The operations of the card processor are seamless from the standpoint of the end user customer The merchant 14 is one of the millions of merchants who accept the credit cards and/or debit cards which the issuer 10 has issued. The issuer 10 sends out monthly statements and provides a statement of the accumulated lottery ticket dollar credits.

The present invention further utilizes the existing lottery infrastructure. The infrastructure includes the state or governmental lottery authority 16 and a lottery processor 18. The lottery authority is typically a governmental or quasi-governmental agency legally charged with running the state lottery. The processor is typically a large processing organization which manages one or more state lotteries under contract with the lottery authority . One of the largest such organizations is GTech Corporation of West Greenwich, R.I. Additional organizations include Automated Wagering, Inc. and Scientific Games, Inc. The processor typically, under contract with the state lottery authority manages the lottery sales terminals which are situated at authorized lottery retailer in the participating state. The processor tracks the sales and the ticket purchases for the state lottery from each of the terminals.

The Lottery Cardholder makes purchases at over 28 million merchant establishments 14. The card processor 12 posts transactions and transfers data to the card issuer. As noted, the card processor 12 may be in house or a third party.

The issuer, with the state lottery's prior approval, then posts transactions to its database and runs an automated algorithm for the award of lottery ticket credit based upon preset criteria which relates the quantity of purchases to the number of lottery ticket credits to be awarded. For example, the algorithm may be set to award lottery tickets up to 1 percent (1%) except where seasonal promotions of greater earnings may be offered by the card issuer to the lottery cardholder (end user) of a customer's paid purchases. Hence, if a customer purchases and pays for $100.00 of merchandise using the card, he may receive a reward of one, two or three lottery tickets. The percentage may be based upon the customer's credit rating, annual interest rate or type of card held (e.g. Regular, Gold, Platinum),

The rewards will appear on the Lottery Cardholder's statement as a premium. The invention contemplates three channels of access and communication between the customer and the card issuer. As shown in FIG. 5, the communication can take place online 51, via a toll free phone line 53 or via mail 55. The online channel will typically be a section of the card issuer's website where the customer can access his or her bank of lottery ticket credits and make purchases of tickets.

Based upon the customer's level of net card charges or card purchases, the card issuer awards a pre-set number of lottery cards or plays. The lottery Cardholder (end user) can then access his or her personal information base of lottery ticket credits and additionally request new tickets deductible from the available balance. The end user can then go on a website and have lottery tickets sent to him or her via email or courier or he can play online.

When ordered, the lottery processor then transfers the lottery numbers to the player through the card issuer by secure upload of the salient data adhering at all times to privacy provisions and security protocols. The present invention provides for a number of optional features. For example, merchants who accept the card may be able to pay bonus rewards for the purchase of specially promoted goods or store brands.

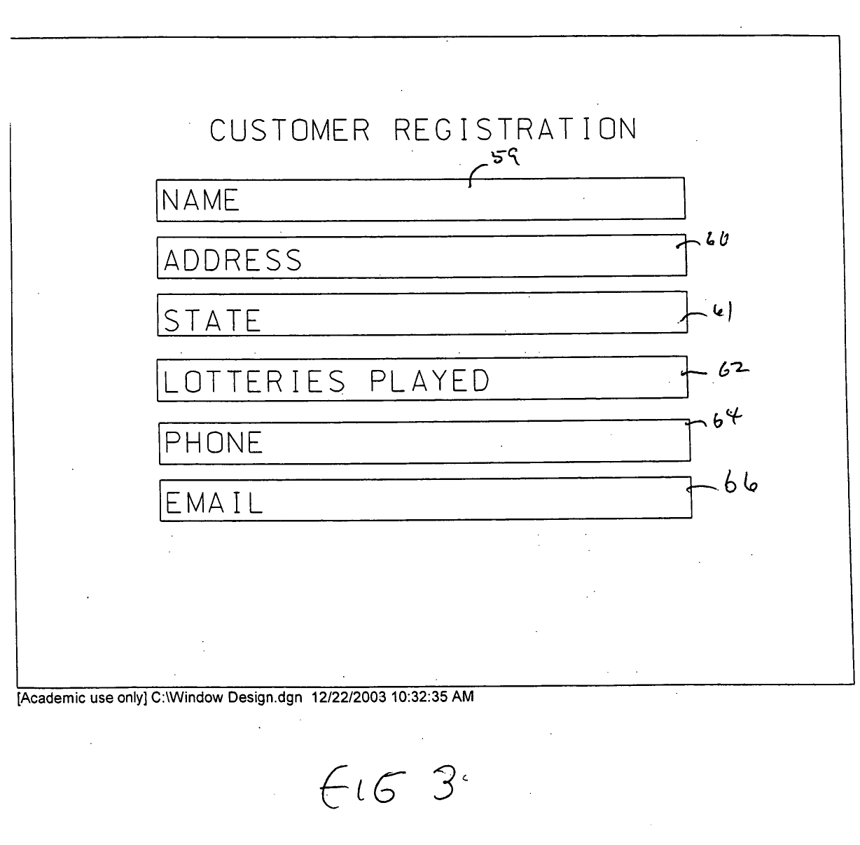

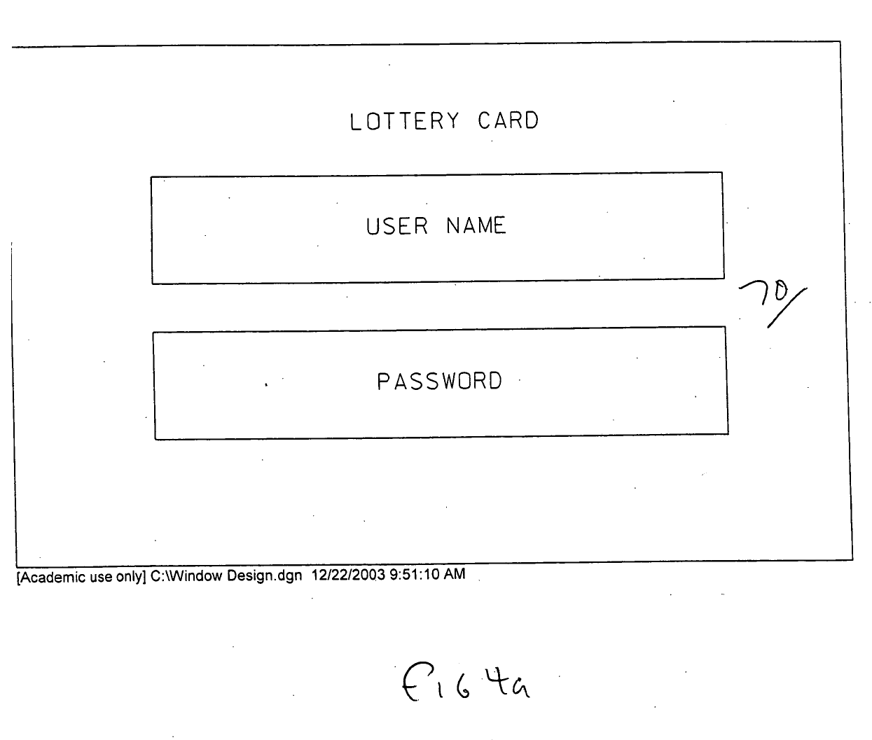

As shown in FIG. 2, the operation system of the present invention works as follows. The end user initially applies for the card 50. When approved, the user then selects, either at the time of the card application or later the games he wishes to play. The player then selects the state that he wishes to play in. The system will determine whether the player can legally play a chosen game in that state. Many states have statutes which govern the terms and conditions under which non-resident players may play lottery games.

After the receipt of the card, the Lottery Cardholder (end user) can then make purchases at one of over 28 million merchants which accept the Lottery Card for payment. Each month as the Lottery Cardholder (end user) gets his or her statement from the issuer 10, he or she will receive credits for lottery tickets based upon the level of paid purchases.

The lottery processor purchases the tickets for the customers and transfers the lottery tickets either electronically or manually, in accordance with applicable regulation and/or Lottery Cardholder request, to the Lottery Cardholder. The ticket data is uploaded to the issuer who posts ticket numbers on the statement. This information may also be accessed via the internet or by toll free number. The tickets can be mailed to the player or be stored virtually in a website. The player can then choose the types of numbers he or she wishes to play via an online interface, via mail or a telephone interface.

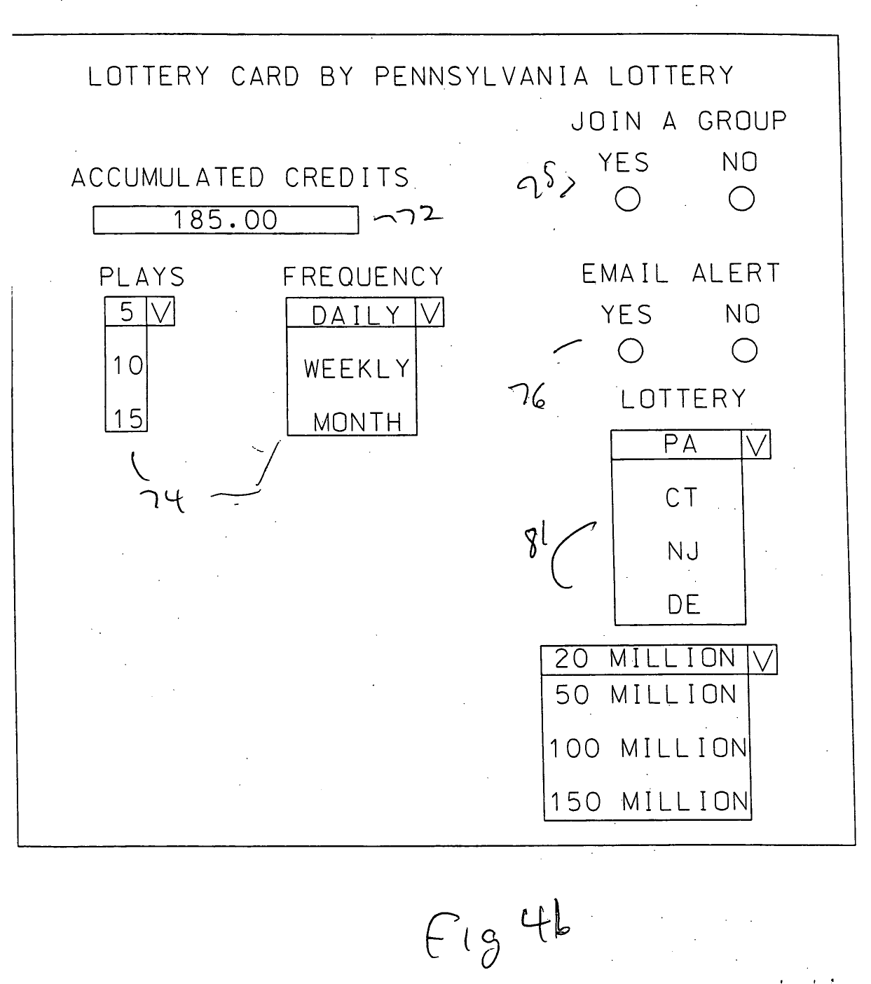

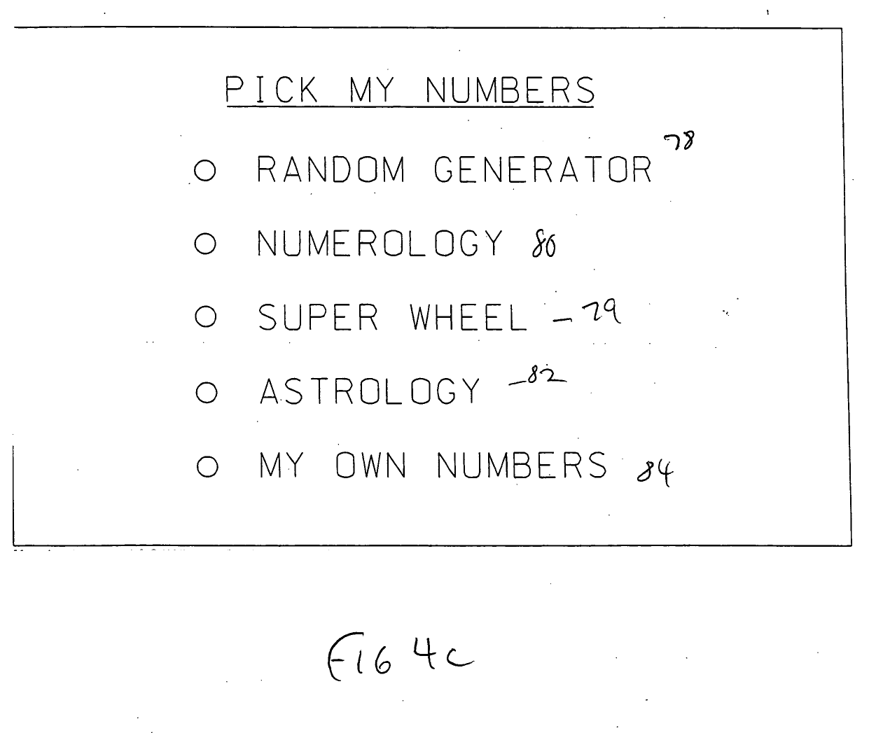

FIG. 3 illustrates a customer registration intake form for the present invention. The form includes critical information such as the user's name 59, address 60, state 61, lotteries played 62, phone 64 and email 66. This information may be provided by paper form, via telephone intake or online interface.

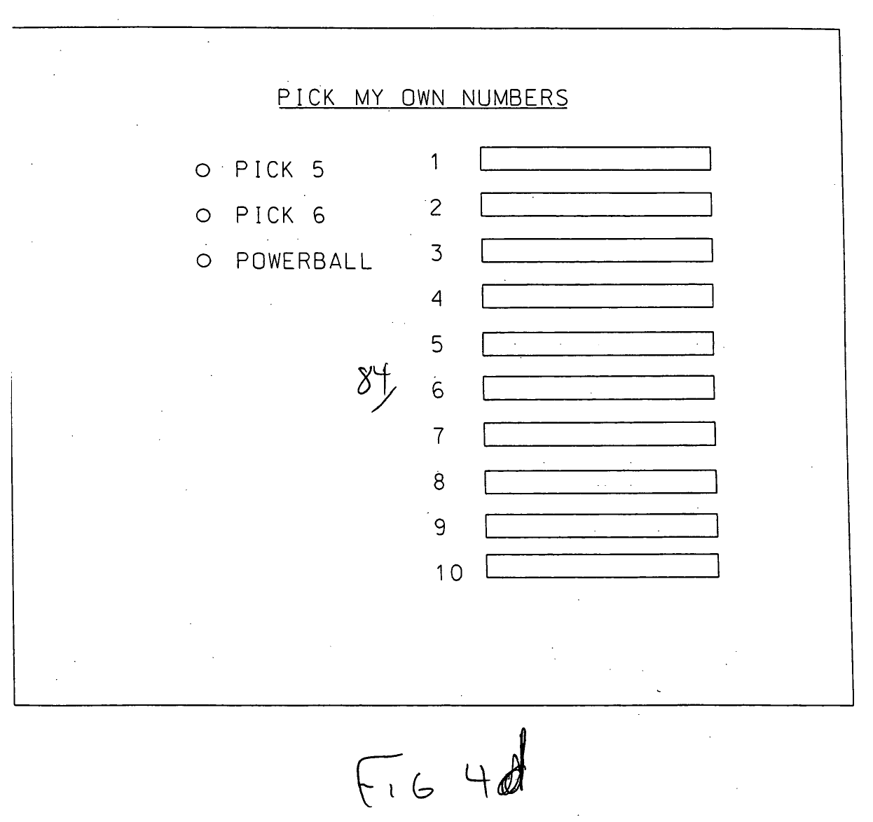

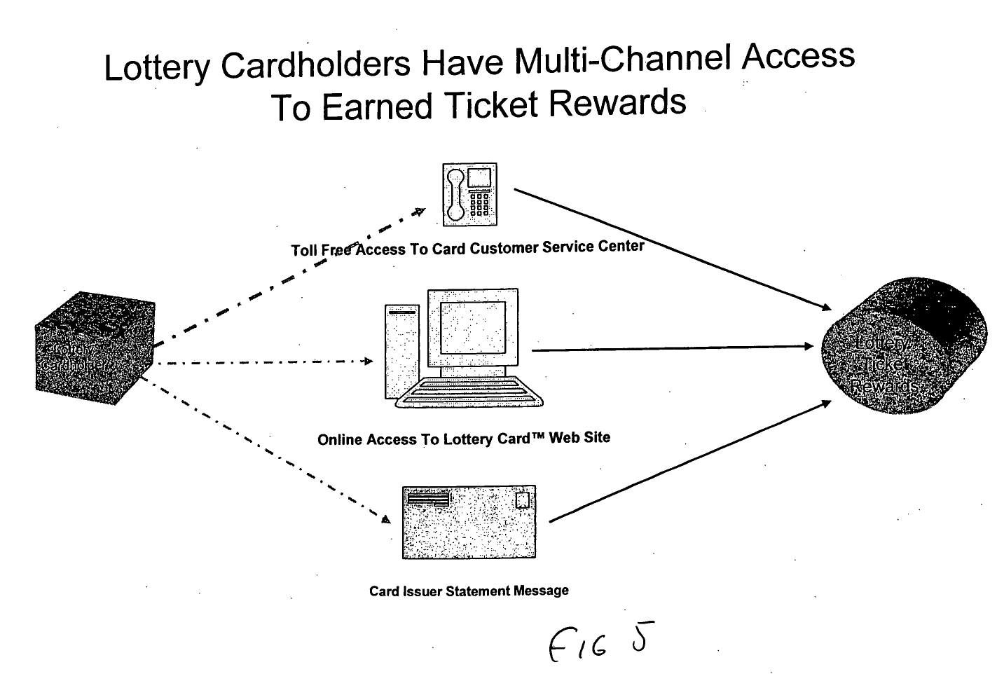

FIGS. 4a-4d illustrates a series of user screens which can be used with an online interface. Initially as shown in FIG. 4a, the end user will receive a password protected interface 70. The user can then go to a screen (FIG. 4b) which shows his/her accumulated plays (credits) 72 and which includes a feature to play a certain number of tickets with a frequency 74. The customer can sign up for an email alert when jackpot interest is high 76. The customer can also join a group with other players 75. As shown in FIG. 4c, the online interface provides the player with ticket generation options, including random generation 78, numerology 80, wheeling 79 or astrology 82. A final screen allows the player to pick specific numbers 84 shown in FIG. 4d.

As noted, among the most popular games are the multistate games such as MegaMillions and Powerball which permit players to play games with a pool of players from multiple states who have the same Card Issuer's Lottery Card. These players can then choose if they are interested in multiple tickets, using numbers they select themselves. One of the other features of the invention is that customers can designate when they want to buy tickets. For example, as shown in FIG. 4b, the system can be set up so that lottery tickets can be purchased only when the lottery reaches a certain jackpot value 81. For example, when the Powerball, Florida or MegaMillions lottery reaches One Hundred Million (100,000,000), the system can be set to make a call to the customer or send an email reminder. In all cases within the context of the invention, tickets are generated to a cardholder based on paid card charges net of revolving balance.

The present invention has been described with reference to the above discussed preferred embodiment. These and other objects of the present invention will become apparent from the claims which follow.

1. A method of issuing lottery tickets to an authorized user of a credit card who incurs debts on the card.
storing in a data processing device an amount of the paid purchase on the credit card by an authorized user of the card;
defining and storing in the data processing device a number representing a monetary amount for which the user can receive a lottery ticket;
calculating in the data processing device a quantity of the lottery tickets earned by the user based on the quantity of paid purchases by the end user; and
crediting the user with the lottery tickets.

2. A novel customer loyalty game played according to the following steps:
registering a customer for a lottery loyalty promotion associated with a credit card; and
providing at least one lottery ticket to the customer, based upon the monetary amount a customer purchases based upon a pre-set algorithm;

3. The novel customer loyalty game of claim 1 further comprising the step of providing additional lottery tickets if the customer's purchases achieve pre-selected minimums of products.

4. The novel customer loyalty game of claim 1 wherein the customer can be awarded additional lottery tickets if the customer purchases certain pre-identified products.

5. A system for operating a customer loyalty game played according to the following steps:
means for inputting customer information and registering the customer to participate in the lottery credit card based customer loyalty game;
means under the control of a computer program for determining the award of lottery tickets based upon pre-selected purchasing parameters;
means for assigning the lottery tickets to a registered customer based upon the spending level of the customer with respect to the purchasing parameters; and
means for providing the end user with the ability to access the numbers.
